(19) United States
(12) Patent Application Publication
(10) Pub. No.: US 2011/0202459 A1
(43) Pub. Date: Aug. 18, 2011

(54) PROCESSING TRANSACTIONS INVOLVING EXTERNAL FUNDS

(75) Inventors: Tushar Shah, Charlotte, NC (US); Jason Blackhurst, Charlotte, NC (US)

(73) Assignee: BANK OF AMERICA CORPORATION, Charlotte, NC (US)

(21) Appl. No.: 12/707,730

(22) Filed: Feb. 18, 2010

(51) Int. Cl. G06Q 40/00

(52) U.S. Cl. 705/44; 705/39

(57) ABSTRACT

Methods, computer readable media, and apparatuses for processing transactions involving external funds are presented. A funding source associated with a financial institution different from a financial institution at which a transaction is being conducted may be identified. The funding source may be validated and registered with the financial institution at which the transaction is being conducted. In some examples, a trust level may be determined for a user associated with the funding source, and the amount of funds available for transacting may be limited based on the trust level. In some examples, an amount of funds from the funding source available for transacting may be limited by an amount of funds associated with the user at the financial institution where the transaction is being conducted. Responsive to risk factors being met, the requested transaction may be rejected automatically. Otherwise, a transaction may be processed with the financial institution with funds drawn from the registered funding source. The transaction may be processed automatically in accordance with a predefined transfer schedule.

### BACKGROUND

The rise of computers and the Internet has allowed customers of financial institutions to manage their money in new and different ways. For example, customers of financial institutions now may view their account balances and statements, pay bills, and otherwise manage their money online.

Some customers, however, may maintain different accounts with different financial institutions. In some instances, these customers may have to interact with multiple online interfaces of different financial institutions to manage their money.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure relate to processing transactions involving external funds. According to one or more aspects, a funding source associated with a first financial institution different from a second financial institution may be identified. Subsequently, the funding source may be registered with the second financial institution. Thereafter, a transaction may be processed at the second financial institution with funds drawn from the registered funding source associated with the first financial institution. According to at least one aspect, the transaction may be processed automatically in accordance with a predefined transfer schedule.

According to one or more additional aspects, the funding source may be validated prior to the registration of the funding source with the second financial institution. In validating a funding source, an amount of funds may be deposited in the funding source at the first financial institution from an account associated with a user at the second financial institution. Subsequently, the user may be queried to confirm the amount of funds deposited in the funding source.

In still other aspects, a trust level may be determined for a user associated with the funding source. Thereafter, an amount of funds available for transacting may be limited based on the determined trust level for the user. According to at least one aspect, different trust levels may correspond to different limits on the amount of funds available for transacting.

According to one or more additional aspects, an amount of funds maintained with the second financial institution by a user associated with the funding source may be determined. Subsequently, in a transaction involving the funding source, an amount of funds of the funding source available for transacting may be limited based on the determined amount of funds maintained with the second financial institution.

According to one or more additional aspects, a payee of a requested transaction may be identified. Thereafter, a risk score may be determined based on whether the identified payee is suspected of fraudulent activity. A frequency at which the identified payee has received one or more deposits may be determined. Further, a currency threshold score may be determined based on whether the transaction exceeds a certain currency threshold. If the determined risk score, frequency, and currency threshold score meet or exceed a predefined risk threshold, the requested transaction may be rejected automatically.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment in which various aspects of the disclosure may be implemented.

FIG. 1B illustrates an example system in which various aspects of the disclosure may be implemented.

FIG. 2 illustrates an example network environment in which various aspects of the disclosure may be implemented.

FIGS. 3A-3C illustrate an example method by which one or more transactions involving external funds may be processed according to one or more aspects described herein.

FIG. 4 illustrates an example method by which a funding source may be validated according to one or more aspects described herein.

FIG. 5 illustrates an example user interface by which one or more transactions may be configured according to one or more aspects described herein.

FIG. 6 illustrates an example user interface by which a funding source may be configured according to one or more aspects described herein.

FIG. 7 illustrates another example user interface by which a funding source may be configured according to one or more aspects described herein.

FIG. 8 illustrates yet another example user interface by which a funding source may be configured according to one or more aspects described herein.

FIG. 9 illustrates an example user interface by which a funding source may be validated according to one or more aspects described herein.

FIG. 10 illustrates another example user interface by which a funding source may be validated according to one or more aspects described herein.

FIG. 11 illustrates yet another example user interface by which a funding source may be validated according to one or more aspects described herein.

FIG. 12 illustrates an example user interface by which one or more transactions involving external funds may be configured according to one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

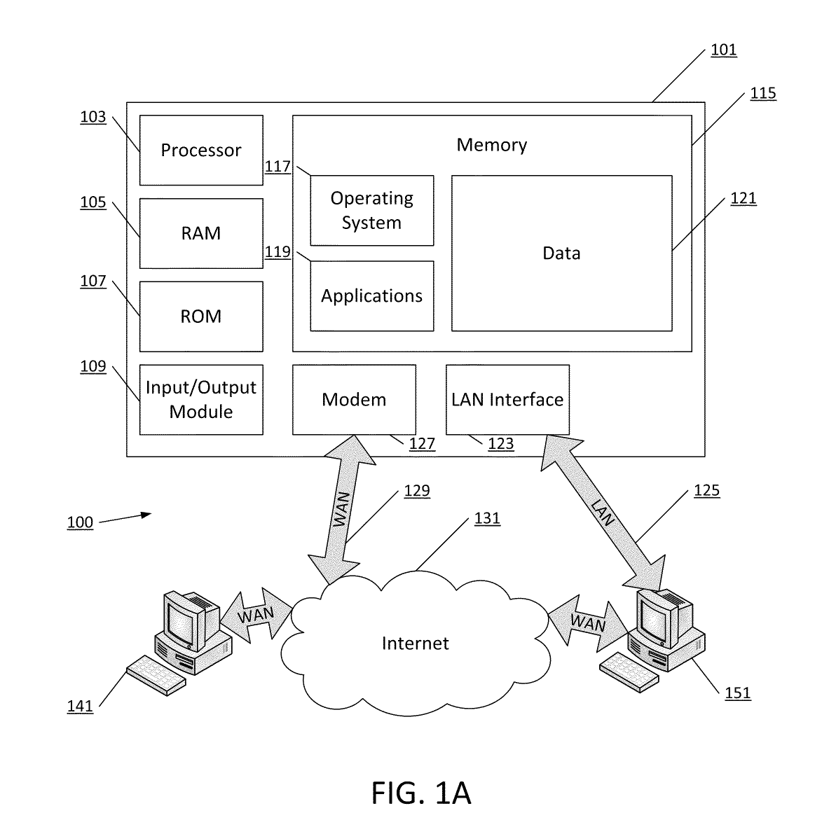

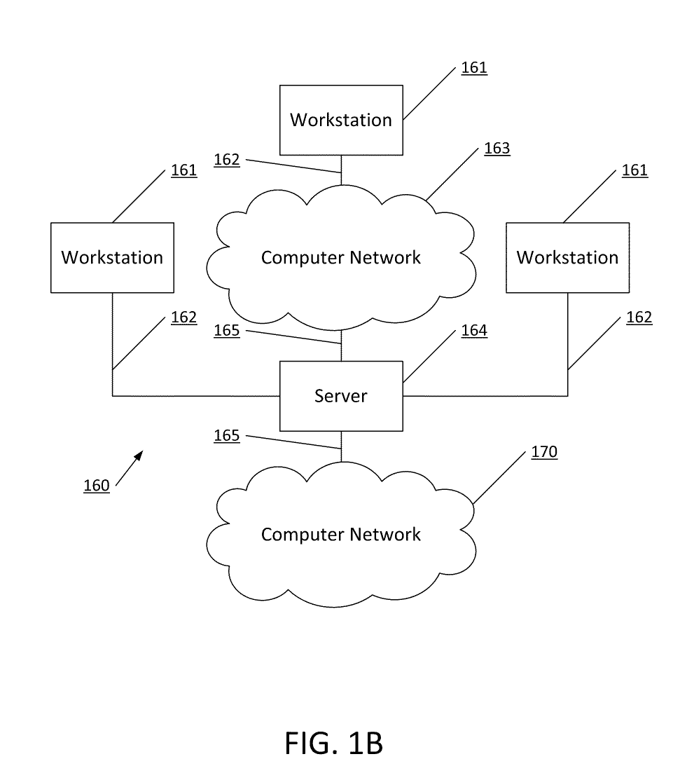

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above relative to the generic computing device 101. The network connections depicted in FIG. 1A include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, handheld or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates an example system 160 in which various aspects of the disclosure may be implemented. As illustrated, system 160 may include one or more workstations 161. Workstations 161 may be local or remote, and may be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via network 163.

Computer network 163 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 162 and 165 may be any communications links suitable for communicating between workstations 161 and server 164, such as network links, dial-up links, wireless links, hard-wired links, etc.

One or more aspects of the disclosure may enable a customer of a financial institution to conduct transactions involving external funds (e.g., funds maintained in an account with another financial institution, different from the previous financial institution). For example, a financial institution may provide an online interface (e.g., a website) through which a customer of the financial institution may be able to view account balances and statements, pay bills, and generally manage their money online. The financial institution further may implement one or more aspects of the disclosure to enable customers of the financial institution to perform various functions using external funds (e.g., funds in an account held at another, unassociated financial institution). For example, a customer of a first financial institution may have a savings account with a second financial institution, different from the first financial institution, and this savings account thus may represent an external funding source. According to one or more aspects of the disclosure, the customer in this example may be able to transfer funds, pay bills, and conduct other transactions involving funds from the external funding source (e.g., the savings account with the second financial institution) through an online interface provided by the first financial institution.

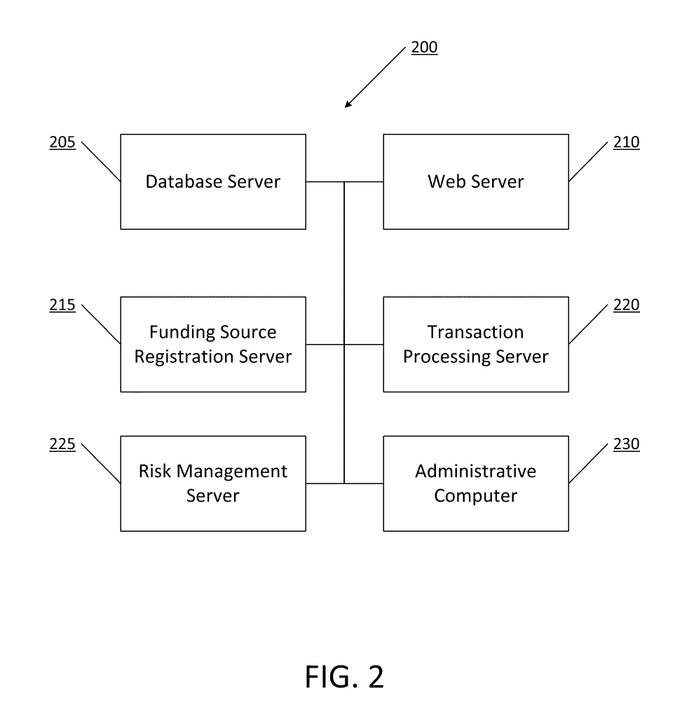

FIG. 2 illustrates an example network environment in which various aspects of the disclosure may be implemented. Network environment 200 may include several computing devices that may be communicatively linked by a network. For example, network environment 200 may include database server 205, web server 210, funding source registration server 215, transaction processing server 220, risk management server 225, and administrative computer 230, and these computing devices may be communicatively linked by one or more network connections.

In one or more arrangements, database server 205 may store, retrieve, and/or process information about one or more users, one or more accounts (e.g., financial accounts, such as savings accounts, checking accounts, money market accounts, loans, mortgages, etc.) that each may be associated with one or more users, one or more user interfaces (e.g., one or more of the user interfaces described below), one or more user preferences, and/or other information and/or data as further described herein. For example, database server 205 may store information about an external funding source (e.g., a funding source held at or associated with a financial institution other than the financial institution at which the transaction is being conducted), configuration information for a transaction involving the external funding source, and/or information related to a user associated with the external funding source. Such information may be used by the system in configuring and/or conducting one or more transactions, as further described below.

In at least one arrangement, web server 210 may store, retrieve, process, and/or display one or more user interfaces (e.g., one or more of the user interfaces described below), as well as information about one or more users, one or more accounts (e.g., financial accounts) that may be associated with one or more users, one or more user preferences, and/or other information and/or data as further described herein. For example, web server 210 may store and/or retrieve information about an external funding source, configuration information for a transaction involving the external funding source, and information related to a user associated with the external funding source, and web server 210 may display a user interface that may include such information. Thus, web server 210 may allow a user to access and/or manipulate remotely a system implementing one or more aspects of the disclosure. Additionally or alternatively, the user interfaces that may be displayed by web server 210 may be used by the system in configuring and/or conducting one or more transactions, as further described below.

In at least one arrangement, funding source registration server 215 may store, retrieve, and/or process information, as well as one or more user interfaces that may be used in registering a funding source. For example, funding source registration server 215 may store, retrieve, and process information, such as account numbers, personal identification numbers, user information, etc., along with a plurality of user interfaces related to a funding source and a user associated with the funding source, which thereby may enable the funding source to be validated and/or registered. For instance, funding source registration server 215 may deposit automatically one or more test deposits in one or more accounts to facilitate the validation of an external funding source, as further described below.

In at least one arrangement, transaction processing server 220 may store, retrieve, and/or process information and/or one or more user interfaces that may be used in processing a transaction. For example, transaction processing server 220 may store, retrieve, and process information, along with a plurality of user interfaces related to a funding source and a user associated with the funding source, which thereby may enable a transaction requested by the user and involving the funding source to be processed, as further described below. For instance, transaction processing server 220 may communicate electronically with an automated clearing house (“ACH”) server to transfer funds between one or more accounts of one or more financial institutions and/or other entities.

In at least one arrangement, risk management server 225 may store, retrieve, and/or process information and/or one or more user interfaces that may be used in managing risk associated with processing a transaction. For example, risk management server may store, retrieve, and process information, such as length of relationship between a client and the financial institution, type of accounts held by the client at the financial institution, number of accounts held by the client at the financial institution, total amount of funds deposited with the financial institution, total debt outstanding owed to the financial institution, credit scores, historical data relating to fraudulent activity, account validation information, etc., along with a plurality of user interfaces related to a funding source, a user associated with the funding source, and a requested transaction, which thereby may enable the management of risk associated with processing the requested transactions, as further described below. For instance, risk management server 225 may determine a trust level for a user associated with the funding source, may determine an amount of funds associated with the user, may identify a payee of the requested transaction, and/or may perform additional analysis. Subsequently, in this example, risk management server 225 may limit the amount of funds available for transacting and/or may reject the requested transaction based on such determined, identified, processed, and/or analyzed information.

In at least one arrangement, administrative computer 230 may generate one or more user interfaces related to system configurations, system status, system logs, and/or other information. Such user interfaces, for example, may enable a user to configure and/or interact with a system implementing one or more aspects of the disclosure. For instance, using an administrative computer 230, an administrative user may be able to configure one or more preferences and/or parameters affecting the determination of trust levels for users and/or limits on transaction amounts imposed by the system in relation to such trust levels, as further described below.

While network environment 200 is described as including various computers adapted to perform various functions, it should be understood that the system may be modified to include a greater or lesser number of computers which may be used alone or in combination to provide the same functionality. For example, a single computer may be used to perform all of the functions described, and one or more users may interact with the single computer through one or more terminals and/or user interfaces. In another example, a first computer may be used to perform all of the functions of database server 205 and web server 210, a second computer may be used to perform all of the functions of funding source registration server 215 and transaction processing server 220, and a third computer may be used to perform all of the functions of risk management server 225 and administrative computer 230. Various other combinations of functionality and computers are possible without departing from the scope of the present disclosure.

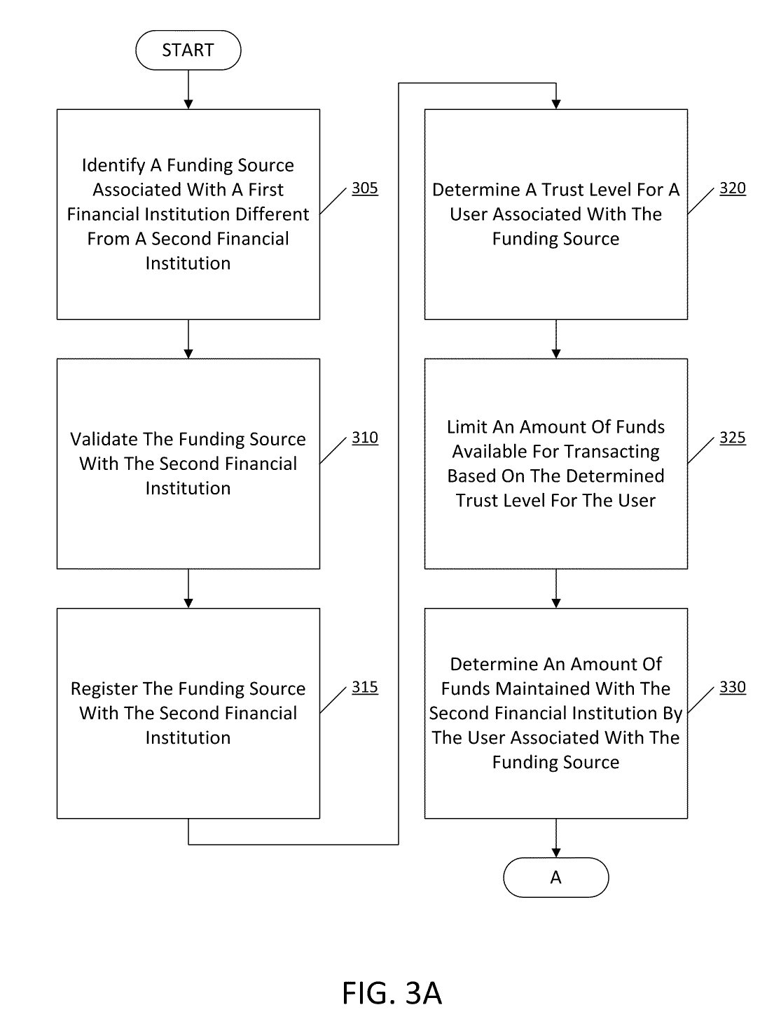

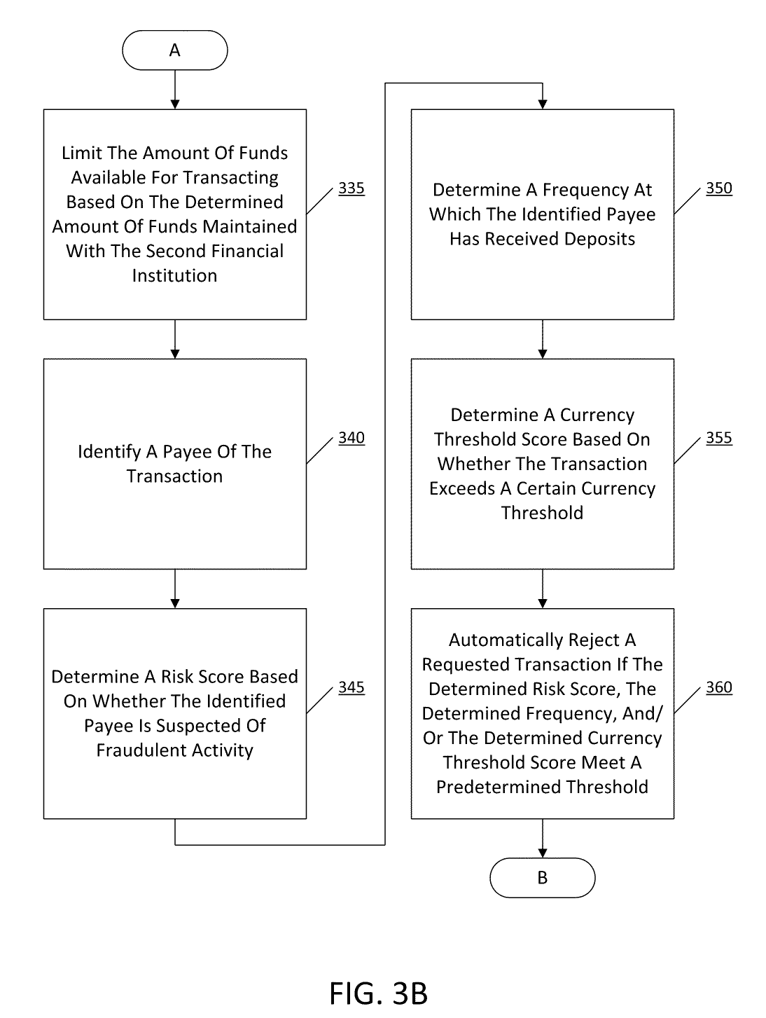

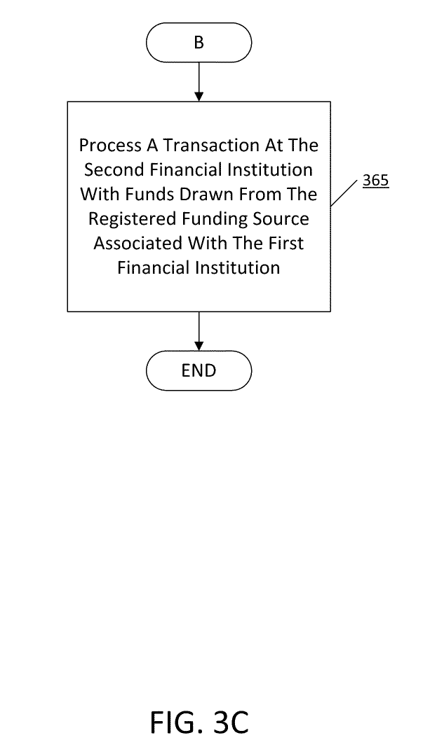

FIGS. 3A-3C illustrate an example method by which one or more transactions involving external funds (e.g., funds held at or associated with a financial institution other than the financial institution at which the one or more transactions are being conducted) may be processed according to one or more aspects described herein. According to one or more aspects, the methods described herein may be implemented by software executed on one or more computers, such as computing device 101, and/or in a network environment, such as network environment 200.

In one or more arrangements, the systems, apparatuses, computer-readable media, interfaces, and/or methods described herein may be implemented with and/or performed in an example scenario in which a user maintains a first financial account with a first financial institution and a second financial account with a second financial institution. The second financial institution may be separate and/or unrelated to the first financial institution. For instance, a user may maintain a brokerage account (e.g., a first financial account) with a wealth management firm (e.g., a first financial institution), and the same user also may maintain a checking account (e.g., a second financial account) with a traditional bank (e.g., a second financial institution). The traditional bank, in this example, may provide online interfaces by which the user may manage his or her funds, such as online interfaces allowing the user to pay his or her bills. In addition, the traditional bank may be unrelated to and/or separate from the wealth management firm. On occasion, such a user may wish to configure and/or conduct transactions with and/or via the second financial institution using funds drawn from the first financial account (e.g., an external funding source) maintained with the first financial institution. For instance, with respect to the user in the example above, the user may wish to configure and/or conduct online bill payment transactions with and/or via the traditional bank (e.g., the second financial institution) using funds drawn from the brokerage account (e.g., the first account) maintained with the wealth management firm (e.g., the first financial institution). Although wealth management firm and a traditional bank are used as examples of financial institutions in this example scenario, many different types of financial institutions could be used, such as credit unions, investment banks, brokerage houses, insurance companies, consumer lending companies, mortgage companies, automobile loan companies, payroll loan companies, etc. In addition, while a brokerage account and a checking account are used as examples of financial accounts in this example scenario, many different types of financial accounts could be used, such as savings account, money market accounts, retirement accounts, lines of credit, credit cards, etc.

Thus, a first financial institution may refer to a financial institution with which a user maintains a first account, and a second financial institution may refer to a different financial institution, unrelated to the first financial institution, through which a user configures and/or conducts a transaction using funds drawn from the first account. In addition, the first financial account may represent a first funding source, and from the perspective of the second financial institution, the first funding source (e.g., the first financial account) may represent an external funding source.

In step 305, a funding source maintained with a first financial institution may be identified. For example, a system implementing one or more aspects of the disclosure may receive user input, and the user input may include information identifying a first funding source (e.g., a first financial account). Information identifying the first financial institution associated with the first funding source (e.g., the name of a bank at which the first account is held) and/or information identifying the account, fund, etc., for instance, may be provided. Such information may include a name of the first funding source (such as the name of the first financial institution name, fund manager name, etc.), an account type identifier, a routing number for the first funding source (which may also be referred to as a “routing transit number” or “RTN,” and which may represent a routing number assigned by an organization, such as THE AMERICAN BANKERS ASSOCIATION), and/or an account number for the first funding source.

For instance, in step 305, a system of a second financial institution may receive “Other Bank 1—Checking” as an account name, “Checking” as an account type, “AAAAAAAAA” as a routing number, and “BBBBBBBBBB” as an account number, and this information may be associated with a first funding source maintained with the first financial institution (e.g., a funding source external to the second financial institution). Thus, based on this information, the system of the second financial institution may identify the first funding source, which may enable additional processing to be performed and/or functionalities to be provided, as further described below.

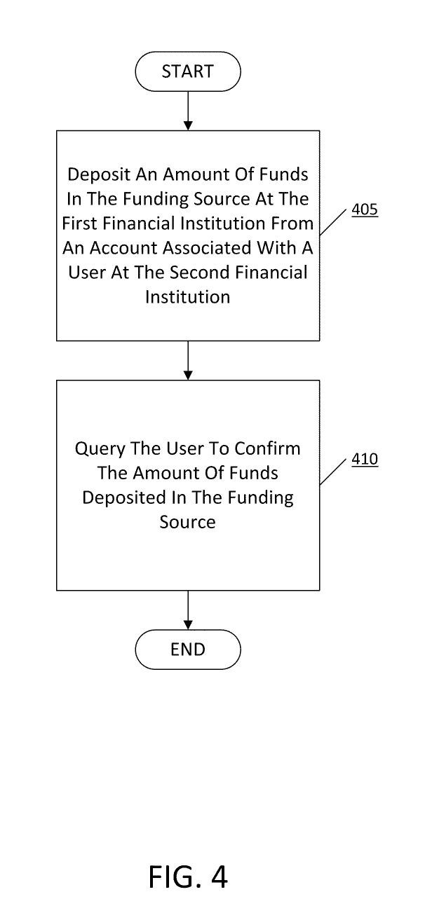

In step 310, the first funding source (e.g., the first financial account) may be validated with the second financial institution. According to one or more aspects, the first funding source may be validated by performing one or more of the steps of the method illustrated in FIG. 4, which is further described below. Such validation may enable the second financial institution to ensure, among other things, that the first funding source has been identified properly and/or that the user who has provided input identifying the first funding source is associated with the first funding source and the first financial institution. Thus, validation may allow the second financial institution to manage risk in processing transactions involving funds from the first funding source.

In step 315, the first funding source maintained with the first financial institution may be registered with the second financial institution. For example, the system, which may provide functionalities to a user associated with the second financial institution, may store information about the first funding source, which again may be a first financial account maintained with the first financial institution, in one or more databases associated with the second financial institution, and the system may allow a user to configure and/or conduct one or more transactions at and/or via the second financial institution involving the first funding source maintained with the first financial institution and/or funds associated therewith. For instance, the user in the preceding example may request to a pay a bill via an online interface provided by the second financial institution, but the user may desire to pay the bill using funds drawn from the first financial account maintained by the user with the first financial institution. By registering the first funding source with the second financial institution, the user may be able to use one or more aspects described herein to pay the bill via the online interface provided by the second financial institution using funds drawn from the first funding source (e.g., the first financial account) maintained with the first financial institution.

For example, in step 315, a system of the second financial institution may store the account name, the account type, the routing number, and the account number for the first funding source. Subsequently, the system may display one or more user interfaces allowing a user to configure and/or conduct one or more transactions at and/or via the second financial institution involving the first funding source (e.g., using funds associated with the first financial account maintained with the first financial institution). In enabling such transactions to be configured and/or conducted, the system may use and/or process the information related to the first funding source in displaying user interfaces and validating transactions to be executed (e.g., the system may confirm that the first funding source has sufficient funds to execute a requested transaction).

Optionally, in step 320, a trust level may be determined at the second financial institution for a user associated with the first funding source. The trust level may be based on one or more factors, such as length of time the user has been a customer of the second financial institution, number of accounts the user has open and/or active with the second financial institution, amount of money the user has deposited with the second financial institution, amount of debt the user owes the second financial institution (e.g., mortgages, personal loans, auto loans, home equity loans, etc.), the credit rating of the user, and/or whether the user previously has been associated with fraudulent activity. In at least one arrangement, the system may determine, automatically, a trust level for a user associated with the first funding source by retrieving and/or analyzing information from one or more databases, such as internal databases that include records related to the user's relationship with the second financial institution and/or external databases that include records related to the user's financial history and other general history.

For instance, a user who has been a customer of the second financial institution (e.g., the financial institution at which the transaction is being conducted) for more than ten years, who has three accounts with the second financial institution (e.g., a checking account, a money market savings account, and a brokerage account), who has over $250,000.00 deposited with the second financial institution, who has no outstanding debts owed to the second financial institution, who has a high credit score, and who has never been associated with fraudulent activity may be determined to have a relatively high degree of trustworthiness, and thus may be associated with a high trust level. On the other hand, a user who has been a customer of the second financial institution for less than one year, who has one account with the second financial institution (e.g., a checking account), who has less than $1,000.00 deposited with the second financial institution, who has a $4,000.00 outstanding debt owed to the second financial institution, who has a low credit score, and who has, at one point, been associated with potentially fraudulent activity may be determined to have a relatively low degree of trustworthiness, and thus may be associated with a low trust level. These factors and scenarios are merely one example set of factors that may be used in determining a trust level for a user. Various other factors, thresholds, etc. may be used without departing from the scope of the present disclosure and nothing in the specification or figures should be viewed as limiting establishing a trust level to only these factors or parameters.

If a level of trust is determined in optional step 320, the amount of funds available for transacting may be limited based on the determined trust level for the user, as shown in step 325. For example, the system may impose a limit on the amount of funds that may be drawn from the first funding source based on the determined trust level for the user. Such a limit may allow the second financial institution to manage risk in processing transactions involving external funds.

For instance, in step 325, the system may allow the user in the example above having a high trust level to configure and/or conduct a transaction involving a greater amount of funds drawn from an external funding source (e.g., the first funding source), than the user in the example above having a low trust level. Thus, the second financial institution may mitigate its exposure to various risks involved in processing transactions involving external funding sources, such as, for example, the risk that the external funding source is overdrawn by, for instance, adjusting a limit on transactions conducted based on the trust level associated with the user.

Optionally, in step 330, an amount of funds maintained at the second financial institution by the user associated with the first funding source may be determined. For example, the system may retrieve and/or analyze information from one or more databases related to the user, and such information and/or analysis may indicate an amount of funds the user has deposited with the second financial institution (e.g., the amount of funds the user has deposited in the second financial account maintained with the second financial institution).

For instance, in step 330, the system may retrieve and analyze information from a database that stores account information associated with the user. Based on the retrieved and analyzed account information, the system may determine that the user has a particular amount of funds deposited with the second financial institution.

If an amount of funds maintained at the second financial institution (e.g., in the second financial account) by the user associated with the first funding source is determined in optional step 330, the amount of funds available for transacting may be limited based on the determined amount of funds maintained at the second financial institution by the user, as shown in step 335. For example, the system may impose a limit on the amount of funds that may be drawn from the first funding source based on the amount of funds the user currently has deposited in the second financial account maintained with the second financial institution. Such a limit may allow a financial institution (e.g., the second financial institution) to manage risk in processing transactions involving external funds. This limit may be determined in conjunction with or independently of a limit associated with a level of trust associated with the user.

For instance, in step 335, the system might not allow the user in the example above to configure and/or conduct a transaction that involves drawing a greater amount of funds from the first funding source than the user currently has deposited with the second financial institution. Thus, the second financial institution may mitigate its exposure to various risks involved in processing transactions involving external funding sources, such as, for example, the risk that the external funding source is overdrawn.

Optionally, in step 340, a payee of the transaction may be identified. For example, the system may receive information identifying a payee, such as a payee name, a payee routing number, a payee account number, and/or a payment amount. For instance, in step 340, the system may receive information identifying a payee via a user interface, and the information may include a payee name (e.g., “Electric Co.”), a payee routing number (e.g., “NNNNNNNNN”), and a payee account number (e.g., “MMMMMMMMMM”).

Optionally, in step 345, a risk score may be determined based on whether the identified payee is suspected of fraudulent activity. For example, the system may retrieve and/or process information from one or more databases, and based on such information and/or processing, the system may determine whether the identified payee is suspected of fraudulent activity. Such a determination may be based on internal records and/or listings that may track entities suspected of fraudulent activity and/or may be based on other information, such as how many other users have configured and/or stored the identified payee as a recipient of funds and/or how long the identified payee has been receiving funds from accounts associated with the first financial institution and/or the second financial institution.

Optionally, in step 350, a frequency at which the identified payee has received one or more deposits may be determined. For example, the system may retrieve and/or process information from one or more databases, and based on such information and/or processing, the system may determine how frequently the identified payee has received one or more deposits from an external funding source (e.g., the first funding source). Analyzing such a frequency may allow a financial institution (e.g., the second financial institution) to manage risk in processing transactions involving external funds (e.g., funds from the first funding source), as a pattern of similar transactions at a similar frequency may suggest that the transactions are approved by the accountholder and/or are legitimate, whereas unusual activity, such as a sporadic burst of high-value transactions may suggest that the transactions are illegitimate and/or that the security of the account has been compromised. For instance, a payment made at regular monthly intervals to a utility company may indicate legitimate payment of a utility bill by the user. On the other hand, a plurality of fund transfers to various offshore accounts over a matter of days and/or in large amounts may indicate illegitimate activity.

Optionally, in step 355, a currency threshold score may be determined based on whether the transaction exceeds a certain currency threshold. For example, the system may be configured such that a plurality of dollar-value thresholds is defined, and each dollar-value threshold may designate a level associated with a particular currency threshold score. For instance, a currency threshold score of “1” may be associated with transactions that are less than $100.00; a currency threshold score of “2” may be associated with transactions that are between $100.00 and $500.00; a currency threshold score of “3” may be associated with transactions that are between $500.00 and $2500.00; a currency threshold score of “4” may be associated with transactions that are between $2500.00 and $10000.00; and a currency threshold score of “5” may be associated with transactions that are more than $10000.00. In this manner, a currency threshold score may be determined based on the amount of the transaction. These ranges and scores are merely one example of providing a score for a currency threshold. Various other monetary ranges, score formats, etc. may be used without departing from the scope of the present disclosure.

In some examples, if optional step 340, optional step 345, optional step 350, and/or optional step 355 are performed, a requested transaction may be rejected automatically if the determined risk score, the determined frequency, and/or the determined currency threshold score meet a predetermined threshold, in step 360. For example, the system may compare the determined risk score, the determined frequency, and/or the determined currency threshold score for a requested transaction to one or more predetermined thresholds, and based on such comparison, the system automatically may reject the requested transaction if the determined risk score, the determined frequency, and/or the determined currency threshold score for the requested transaction meet and/or exceed the one or more predetermined thresholds.

For instance, in step 360, the system may determine, for a first requested transaction, that the risk score is high, that the frequency is sporadic, and that the currency threshold score is high. Thus, in this example, the system automatically may reject the first requested transaction based on these determinations. On the other hand, the system may determine, for a second requested transaction, that the risk score is low, that the frequency is regular, and that the currency threshold score is moderate. In view of these determinations, the system might not reject the second requested transaction in this example.

In step 365, a transaction may be processed at the second financial institution with funds drawn from the first funding source (e.g., the first financial account maintained by the user with the first financial institution). For example, the system may transfer funds from the registered first funding source (e.g., the first financial account maintained by the user with the first financial institution) to the second financial account maintained at the second financial institution or to another external account (e.g., a payee's account at the second financial institution or at an external financial institution, such as the first financial institution). Additionally or alternatively, the transaction being processed may include payment of a bill via the second financial institution (such as an online bill pay system at the second financial institution) using funds drawn from the first funding source.

For instance, in step 365, the system previously may have received configuration information (e.g., an account name, a routing number, an account number, and/or the like) associated with a transaction involving funds drawn from an external funding source (e.g., the first financial account maintained by the user at the first financial institution), and thus the system may use such information to process and/or execute the transaction. For example, the system may use the routing number and the account number to withdraw funds electronically from an external funding source, such as the first financial account maintained by the user at the first financial institution.

FIG. 4 illustrates an example method by which a first funding source may be validated according to one or more aspects described herein. In step 405, an amount of funds may be deposited, as a test, in the first funding source (e.g., the first financial account) maintained by the user with the first financial institution, from the second financial account maintained by the same user with the second financial institution. The one or more test deposits may include a minimal amount of funds (e.g., $0.55, $0.35, etc.). Such test deposits may allow the system to confirm that the first funding source has been configured properly, and/or may allow the system to confirm that the first funding source is associated with the user, as further described below.

In step 410, the user may be queried to confirm the amount of funds deposited in the first funding source. For example, the system, via one or more user interfaces, may prompt the user to enter the amounts of the one or more test deposits made in the previous example. Then, the user may enter, and the system may receive via the one or more user interfaces, the amounts of the one or more test deposits. Subsequently, the system may compare the amounts indicated as received by the user with the amounts actually deposited in the first funding source by the second financial institution. If the system determines that the amounts received from the user via the user interface match the deposited amounts, the system may designate the first funding source as validated, which may enable the first funding source (associated with the first financial institution) to be registered with the second financial institution and subsequently used in processing transactions. On the other hand, if the system determines that the amounts received from the user via the user interface do not match the deposited amounts, the system might not designate the first funding source as validated, which might prevent the first funding source from being registered with the second financial institution.

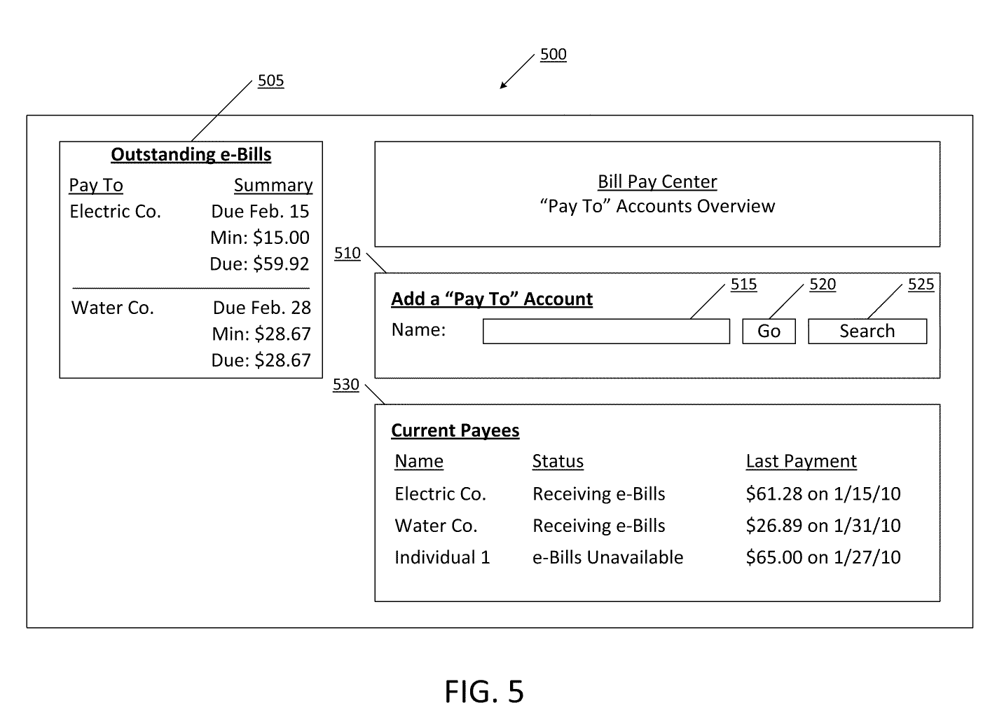

FIG. 5 illustrates an example user interface by which one or more transactions may be configured according to one or more aspects described herein. According to one or more aspects, the user interfaces described herein may be implemented by software executed on one or more computers, such as computing device 101, and/or in a network environment, such as network environment 200.

In one or more configurations, user interface 500 may enable a user to add one or more payees to a list of stored payees. Such a list of payees may be used by the user and/or by the system in processing transactions, as further described below. For example, user interface 500 may include outstanding bill information box 505. Outstanding bill information box 505 may include information about one or more outstanding bills. For instance, user interface 500 may include an outstanding bill from “Electric Co.” and related information (e.g., “Due Feb. 15”), as well as an outstanding bill from “Water Co.” and related information (e.g., “Due Feb. 28”). By using outstanding bill box 505, a user may schedule, configure, cause to be processed, and or cause to be executed one or more transactions (e.g., payments of outstanding bills).

In at least one configuration, user interface 500 further may include add payee box 510. By using add payee box 510, a user may add one or more payees to a list of stored payees. For example, add payee box 510 may include name text box 515, go button 520, and search button 525. In adding one or more payees to a list of stored payees using user interface 500, a user may enter the name of a new payee into name text box 515. If the system recognizes the name of the new payee, which may be indicated by a text search auto-complete macro, the user may activate go button 520 to add the new payee to the list of stored payees. Additionally or alternatively, if the system does not recognize the name of the new payee, the system might search one or more databases that include payee names and/or other information related to payees, and the system automatically may suggest possible payee names and/or billing information based on the information included in the one or more databases.

In addition, user interface 500 further may include current payees box 530. Current payees box 530 may include information about one or more payees that may already be included in a list of stored payees, and thus current payees box 530 may enable a user to view existing information stored and/or used by the system. For example, current payees box 530 may include, for each payee, an account name (e.g., “Electric Co.”), a status (e.g., “Receiving e-Bills”), and a previous payment amount (e.g., $61.28).

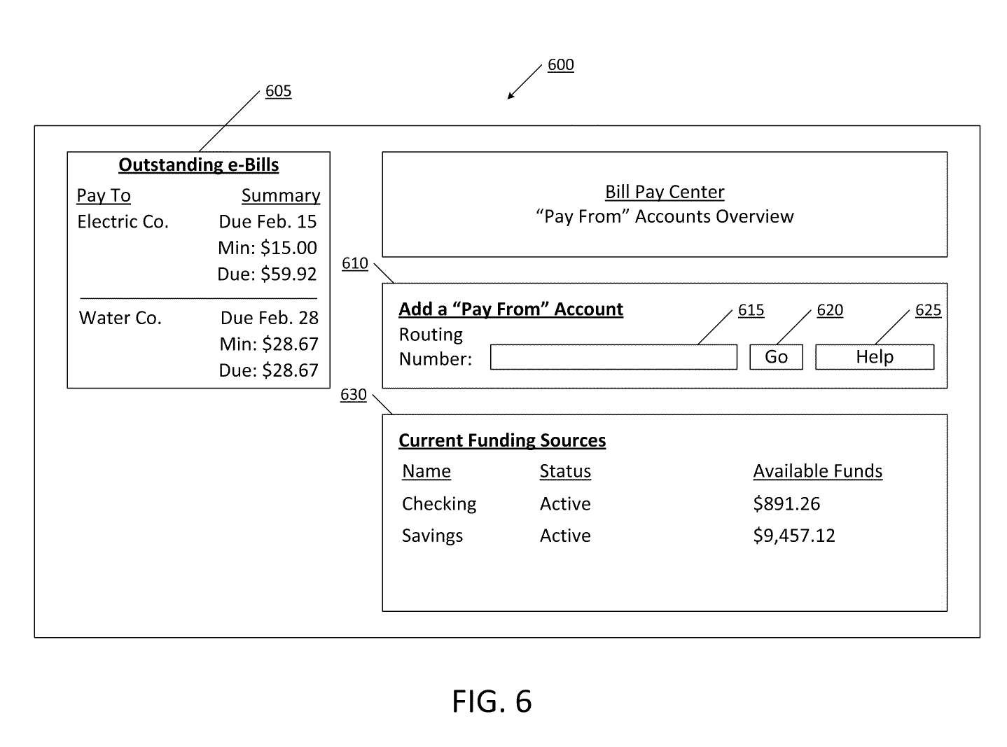

FIG. 6 illustrates an example user interface by which a funding source may be configured according to one or more aspects described herein. In one or more configurations, user interface 600 may include outstanding bill information box 605, which may be similar to and/or provide similar functionalities as outstanding bill information box 505.

In at least one configuration, user interface 600 further may include add account box 610. By using add account box 610, a user may be able to add one or more funding sources to a list of stored funding sources. For instance, the user may add funding sources that are internal to the financial institution (e.g., a financial account maintained by the user with the second financial institution) and/or external funding sources that are associated with other financial institutions (e.g., a financial account maintained by the user with the first financial institution). For example, add account box 610 may include routing number text box 615, go button 620, and help button 625. In adding a funding source to a list of stored funding sources using user interface 600, a user may enter a routing number associated with the funding source, and then the user may activate go button 620. If the user requires assistance, the user may activate help button 625, and the system may display help information, which may assist the user in adding a funding source using user interface 600.

In addition, user interface 600 may include current funding sources box 630. Current funding sources box 630 may include information about one or more funding sources that may already be included in a list of stored funding sources, and thus current funding sources box 630 may enable a user to view existing information stored and/or used by the system. For example, current funding sources box 630 may include, for each funding source, an account name (e.g., “Checking”), a status (e.g., “Active”), and an amount of available funds (e.g., “$891.26”).

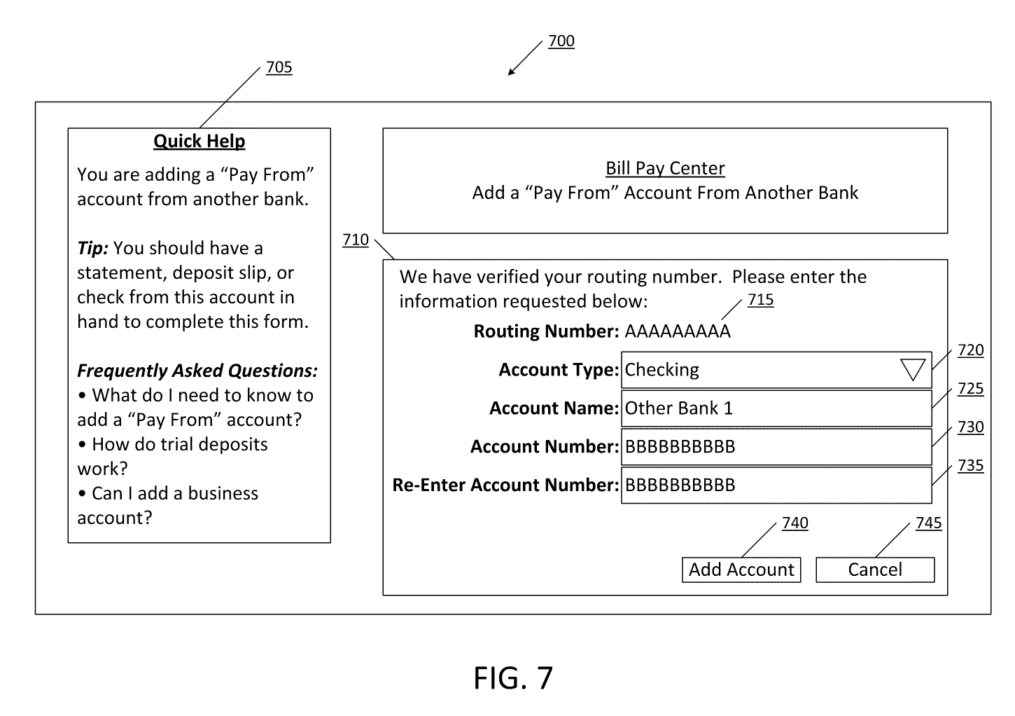

FIG. 7 illustrates another example user interface by which the first funding source (e.g., the first financial account held at or associated with the first financial institution) may be configured, such as at the second financial institution, according to one or more aspects described herein. As discussed above, in one or more arrangements, the systems, apparatuses, computer-readable media, interfaces, and/or methods described herein may be implemented with and/or performed in an example scenario in which a user maintains a first financial account with a first financial institution and a second financial account with a second financial institution. The second financial institution may be separate from and/or unrelated to the first financial institution. Thus, a first financial institution may refer to a financial institution with which a user maintains a first account, and a second financial institution may refer to a different financial institution, unrelated to the first financial institution, through which a user configures and/or conducts a transaction using funds drawn from the first account. In addition, the first financial account may represent a first funding source, and from the perspective of the second financial institution, the first funding source (e.g., the first financial account) may represent an external funding source.

In one or more configurations, user interface 700 may enable a user to provide configuration details about the first funding source. Such configuration details may facilitate the processing of transactions at the second financial institution with funds drawn from the first funding source, such as the payment of a bill via an online interface provided by the second financial institution using funds drawn from the first funding source maintained by the user with the first financial institution.

In at least one arrangement, user interface 700 may include quick help box 705. Quick help box 705 may include information that may assist a user who is providing configuration details about an external funding source via user interface 700. For instance, quick help box 705 may include one or more usage tips and/or one or more frequently asked questions.

Additionally or alternatively, user interface 700 may include account configuration box 710. By using account configuration box 710, a user may provide additional configuration details about the first funding source to be added to a set of funding sources associated with the user. For example, account configuration box 710 may include routing number indicator 715, account type selection menu 720, account name text box 725, account number text box 730, reentered account number text box 735, add account button 740, and cancel button 745.

In at least one configuration, routing number indicator 715 may reflect a routing number entered into routing number text box 615 in user interface 600. Account type selection menu 720 may allow a user to select an account type associated with the external funding source (e.g., checking, savings, brokerage, line of credit, and/or the like). Account name text box 725 may allow the user to associate the external funding source with a name (e.g., “Other Bank 1—Checking”). Account number text box 730 and reentered account number text box 735 may allow a user to enter an account number associated with the external funding source. In at least one arrangement, it may be desirable to require the user to enter the account number in both account number text box 730 and reentered account number text box 735 so as to reduce the likelihood that the user inadvertently adds an incorrect account due to an error in data entry. Once the user has filled in one or more of the fields in account configuration box 710, the user may activate add account button 740 to add the external funding source to a set of funding sources associated with the user. Alternatively, the user may activate cancel button 745 to cancel entry of configuration details for the external funding source.

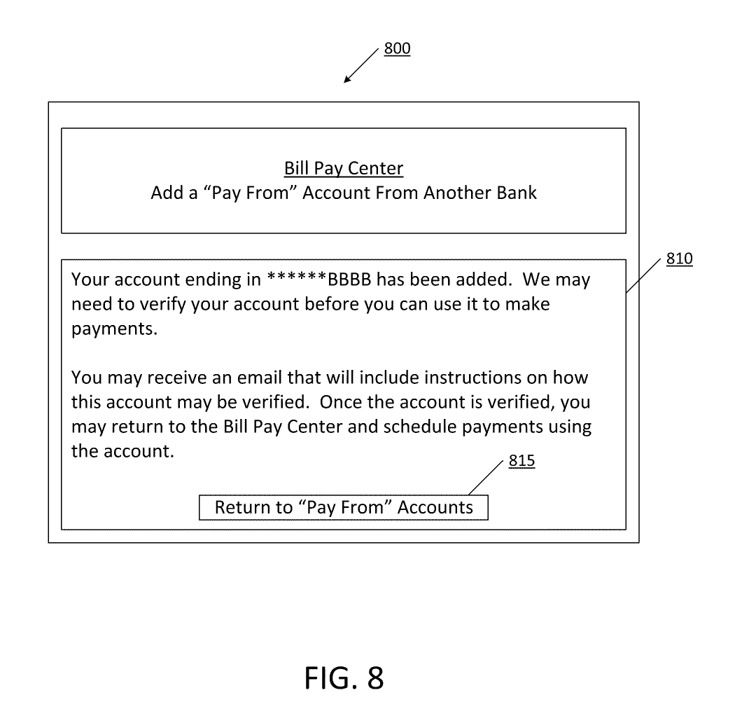

FIG. 8 illustrates yet another example user interface by which the first funding source may be configured according to one or more aspects described herein. In one or more configurations, user interface 800 may be displayed after a user provides additional configuration details about the first funding source to be added to a set of funding sources associated with the user.

For example, user interface 800 may include information box 810. Information box 810 may provide information to the user about registering the first funding source with the second financial institution and/or other information. For instance, information box 810 may notify a user that the first funding source has been added, and information box 810 may notify the user that the first funding source may need to be verified before it may be used in processing transactions. Additionally or alternatively, user interface 800 may include a return to accounts page button 815. By activating return to accounts page button 815, a user may cause to be displayed one or more user interfaces (e.g., user interface 900, which is further described below) by which the first funding source may be validated and/or used in processing one or more transactions at the second financial institution.

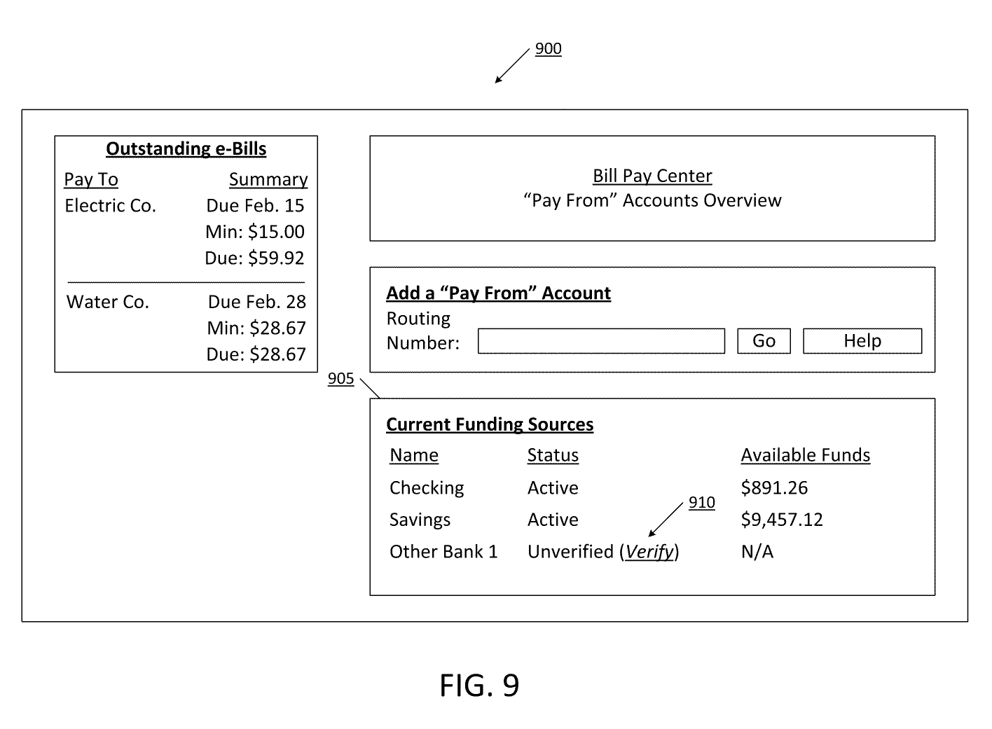

FIG. 9 illustrates an example user interface by which the first funding source may be validated, such as at the second financial institution, according to one or more aspects described herein. In one or more configurations, user interface 900 may be similar to and/or provide similar functionalities as user interface 600. User interface 900, however, illustrates how current funding sources box 905 may be updated to include an added external funding source (e.g., “Other Bank 1”).

In current funding sources box 905, the added external funding source (which is “Other Bank 1” in the illustrated example in FIG. 9) may be unverified (as indicated by the “Unverified” status indicator associated with the “Other Bank 1” listing in current funding sources box 905). As further discussed above, when the first funding source is unverified, it might not be possible to process one or more transactions at the second financial institution involving the unverified first funding source. Current funding sources box 905, however, may include verify link 910 adjacent to the status indicator of “Unverified.” By activating verify link 910, one or more user interfaces (e.g., user interface 1000, which is further described below) may be displayed that may allow the first funding source to be verified at the second financial institution, and funds from the verified first funding source may be drawn on in conducting transactions at the second financial institution.

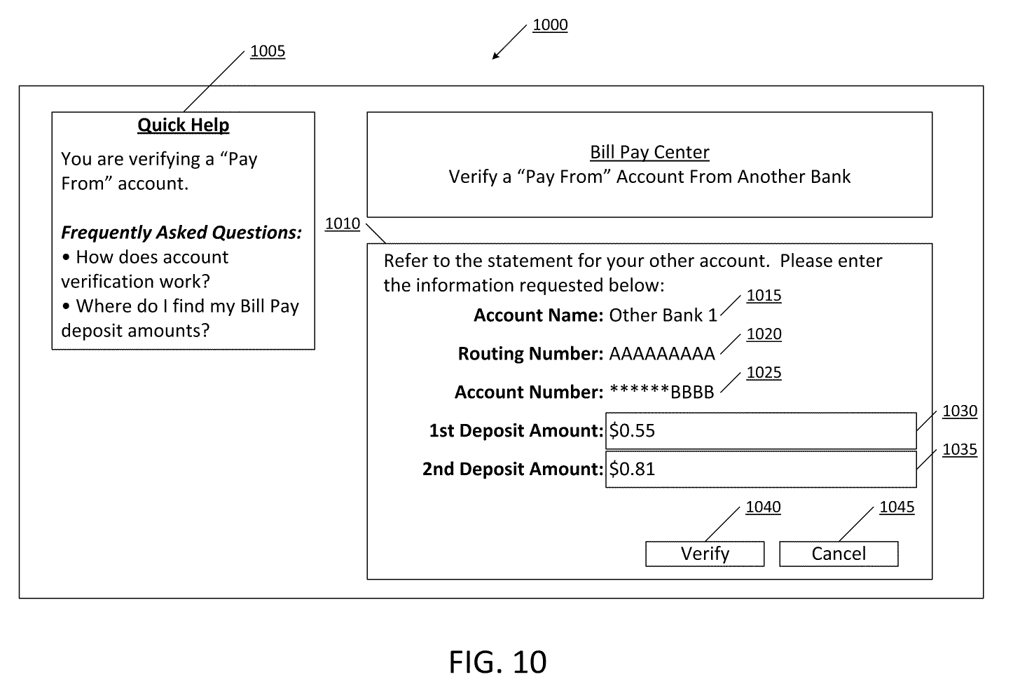

FIG. 10 illustrates another example user interface by which the first funding source may be validated according to one or more aspects described herein. In one or more configurations, user interface 1000 may enable a user to provide account verification information. Such verification information may allow the system to validate the first funding source and/or may enable a financial institution (e.g., the second financial institution) to manage risk associated with processing transactions involving the first funding source.

In at least one configuration, user interface 1000 may include quick help box 1005. Quick help box 1005 may be similar to and/or provide similar functionalities as quick help box 705.

Additionally or alternatively, user interface 1000 may include account verification box 1010. Account verification box 1010 may include information related to an external funding source and/or the validation of the external funding source. For example, account verification box 1010 may include an account name 1015 associated with the external funding source (e.g., “Other Bank 1”), a routing number 1020 associated with the external funding source (e.g., “AAAAAAAAA”), and an account number 1025 associated with the first funding source (e.g., “BBBBBBBBBB”).

In at least one configuration, user interface 1000 further may include first deposit amount text box 1030 and second deposit amount text box 1035. A user thus may enter a first deposit amount and a second deposit amount in first deposit amount text box 1030 and second deposit amount text box 1035, respectively. As discussed above, the first deposit amount and the second deposit amount may represent test deposits that may be made automatically by the system. After such test deposits are made, to validate the first funding source at the second financial institution, the user may be queried, via user interface 1000, for example, to confirm the amount of funds deposited in the first funding source. Thus, the system may compare the user's entries into first deposit amount text box 1030 and second deposit amount text box 1035 with the amounts actually deposited in the first funding source. In this manner, the test deposits may allow the system to confirm that the first funding source has been configured properly, and/or may allow the system to confirm that the first funding source is associated with the user.

In addition, user interface 1000 may include verify button 1040 and cancel button 1045. Once the user has filled in one or more of the fields in account verification box 1010, the user may activate verify button 1040 to validate the first funding source, as further described above. Alternatively, the user may activate cancel button 1045 to cancel entry of account verification information for the first funding source.

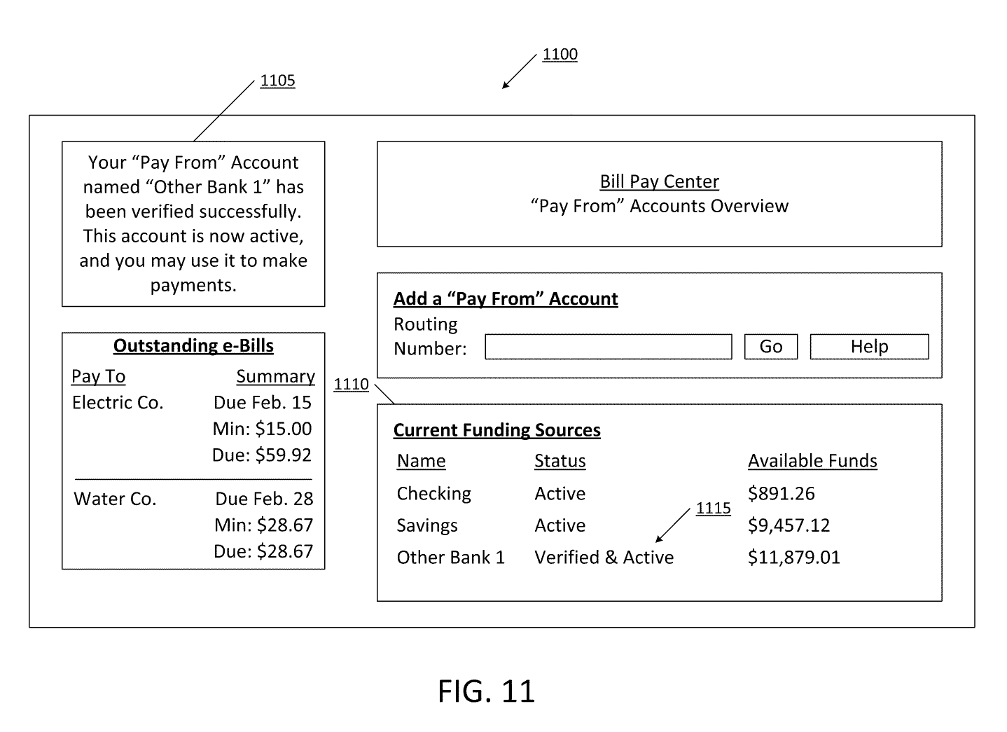

FIG. 11 illustrates yet another example user interface by which the first funding source may be validated according to one or more aspects described herein. In one or more configurations, user interface 1100 may be displayed after a user provides account verification information for the first funding source.

For example, user interface 1100 may include information box 1105. Information box 1105 may provide information to the user about the status of validation of the first funding source, such as at the second financial institution, and/or other information. For instance, information box 1105 may notify a user that the first funding source has been verified successfully and thus may be used in processing one or more transactions. Additionally or alternatively, current funding sources box 1110 and verification status indicator 1115 may be updated to reflect the successful verification of the first funding source (e.g., “Other Bank 1”).

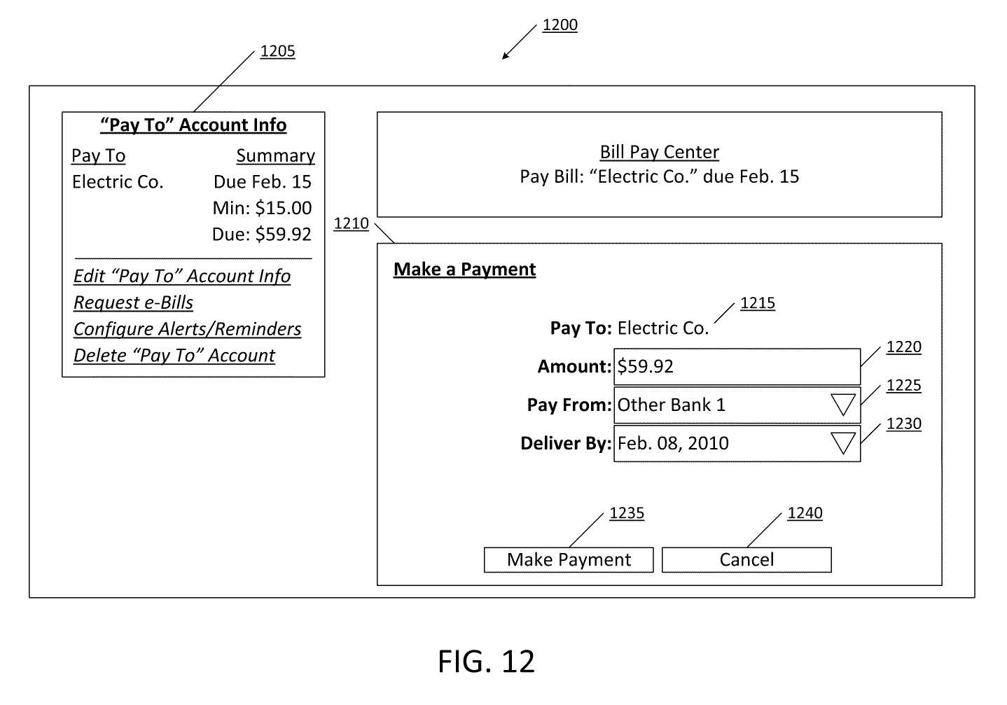

FIG. 12 illustrates an example user interface by which one or more transactions involving external funds (e.g., funds held at financial institutions other than the financial institution at which the transaction is occurring) may be configured according to one or more aspects described herein. In one or more configurations, user interface 1200 may include payee account info box 1205. Payee account info box may include information about a payee (e.g., “Electric Co.”) and/or one or more outstanding bills (e.g., “Due Feb. 15”). Further, payee account info box may include one or more hyperlinks (e.g., “Edit ‘Pay To’ Account Info,” “Request e-Bills,” “Configure Alerts/Reminders,” and “Delete ‘Pay To’ Account”), and each hyperlink may allow the user to create, modify, and/or delete information and/or preferences related to the payee.

Additionally or alternatively, user interface 1200 further may include transaction configuration box 1210. Transaction configuration box 1210 may allow a user to configure one or more aspects of a transaction to be processed. For example, transaction configuration box 1210 may include payee identifier 1215, transaction amount text box 1220, transaction funding source menu 1225, transaction date menu 1230, make payment button 1235, and cancel button 1240. Payee identifier 1215 may reflect a payee selected in another user interface (e.g., user interface 1100). Transaction amount text box 1220 may allow a user to enter an amount of money for the transaction to be processed. In the example illustrated in FIG. 12, the transaction amount thus may be “$59.92.” Transaction funding source menu 1225 may allow a user to select a funding source (e.g., an internal funding source (e.g., an account held at the second financial institution at which the transaction is taking place) and/or an external funding source (e.g., an account held at a financial institution other than the second financial institution where the transaction is taking place)) to be used in processing the transaction. For instance, with regard to the examples illustrated and described above, the user may be able to choose from “Checking,” “Savings,” and “Other Bank 1.” Transaction date menu 1230 may allow the user to specify a date on which the transaction is to be processed. Once the user has filled in one or more of the fields in transaction configuration box 1210, the user may activate make payment button 1235 to save the configured transaction for processing. Alternatively, the user may activate cancel button 1240 to cancel entry of configuration details for the transaction.

According to one or more aspects, if the user selects the first funding source (e.g., the first financial account maintained by the user with the first financial institution) from transaction funding source menu 1225, such as, for example, “Other Bank 1,” a transaction may be configured and/or conducted at the second financial institution in which funds are transferred directly from the first funding source (e.g., the first financial account maintained by the user with the first financial institution) to the one or more payees identified in payee identifier 1215. According to at least one additional aspect, if the user selects the first funding source (e.g., the first financial account maintained by the user with the first financial institution) from transaction funding source menu 1225, such as, for example, “Other Bank 1,” a transaction may be configured and/or conducted at the second financial institution in which funds are transferred from the first funding source (e.g., the first financial account maintained by the user with the first financial institution) to the second financial account associated with the second financial institution (e.g., the financial institution providing user interface 1200 to the user) and then to the one or more payees identified in payee identifier 1215.

In at least one configuration, a user may configure a transaction to repeat according to a defined transfer schedule. For example, user interface 1200 may allow the user to specify multiple transaction dates in transaction date menu 1230, multiple transaction amounts in transaction amount text box 1220, and/or multiple transaction funding sources in transaction funding source menu 1225. In this manner, the system may be configured to process one or more transactions automatically in accordance with a predefined transaction schedule.

For instance, a user may wish to conserve the funds in an external brokerage account as savings and use the funds in an internal checking account for spending. The user may maintain the external brokerage account with a wealth management firm, and the user may maintain the internal checking account with a traditional bank that is unrelated to the wealth management firm. The external brokerage account thus may represent a first financial account maintained by the user with a first financial institution, and the internal checking account thus may represent a second financial account maintained by the user with a second financial institution, the second financial institution being different from, separate from, and/or unrelated to the first financial institution. Further, the user may wish to have his or her paycheck deposited in the external brokerage account at the first financial institution, such that spending funds may be transferred from the external brokerage account to the internal checking account at the second financial institution. By defining a transaction schedule, the user may be able to arrange for such transfers to occur automatically. Indeed, the user may configure a system implementing one or more aspects of the disclosure (e.g., using one or more of the user interfaces described herein, such as interface 1200) to transfer $800.00 automatically every other week from the external brokerage account at the first financial institution into the internal checking account at the second financial institution. Thus, the system may be configured to process automatically transactions involving a funding source associated with a different financial institution according to a predefined transaction schedule, which may be created by the user.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A method, comprising:
identifying a funding source associated with a first financial institution different from a second financial institution;
registering the funding source with the second financial institution; and
processing a transaction at the second financial institution with funds drawn from the registered funding source associated with the first financial institution.

2. The method of claim 1, further comprising:
validating the funding source prior to registering the funding source with the second financial institution.

3. The method of claim 2, wherein validating the funding source includes:
depositing an amount of funds in the funding source at the first financial institution from an account associated with a user at the second financial institution; and
querying the user to confirm the amount of funds deposited in the funding source.

4. The method of claim 3, wherein the funding source at the first financial institution is associated with the user associated with the account at the second financial institution.

5. The method of claim 1, wherein the transaction is processed automatically in accordance with a predefined transfer schedule.

6. The method of claim 1, further comprising:
determining a trust level for a user associated with the funding source; and
limiting an amount of funds available for transacting based on the determined trust level for the user.

7. The method of claim 6,
wherein a first determined trust level corresponds to a first limit on the amount of funds available for transacting, and
wherein a second determined trust level corresponds to a second limit on the amount of funds available for transacting, the second determined trust level being different from the first determined trust level, and the second limit being different from the first limit.

8. The method of claim 1, further comprising:
determining an amount of funds maintained with the second financial institution by a user associated with the funding source; and
limiting an amount of funds of the funding source available for transacting based on the determined amount of funds maintained with the second financial institution.

9. The method of claim 1, further comprising:
identifying a payee of the transaction;
determining a risk score based on whether the identified payee is suspected of fraudulent activity;
determining a frequency at which the identified payee has received one or more deposits;
determining a currency threshold score based on whether the transaction exceeds a certain currency threshold; and
responsive to at least one of the determined risk score, the determined frequency, and the determined currency threshold score meeting a predetermined threshold, automatically rejecting a requested transaction.

10. One or more computer-readable media having computer-executable instructions stored thereon, that when executed by one or more processors, cause the one or more processors to perform:
identifying a funding source associated with a first financial institution different from a second financial institution;
registering the funding source with the second financial institution; and
processing a transaction at the second financial institution with funds drawn from the registered funding source associated with the first financial institution.

11. The computer-readable media of claim 10, having additional computer-executable instructions stored thereon, that when executed by the one or more computers, cause the one or more computers to perform:
validating the funding source prior to registering the funding source with the second financial institution.

12. The computer-readable media of claim 11, wherein validating the funding source includes:
depositing an amount of funds in the funding source at the first financial institution from an account associated with a user at the second financial institution; and
querying the user to confirm the amount of funds deposited in the funding source.

13. The computer-readable media of claim 12, wherein the funding source at the first financial institution is associated with the user associated with the account at the second financial institution.

14. The computer-readable media of claim 10, wherein the transaction is processed automatically in accordance with a predefined transfer schedule.

15. The computer-readable media of claim 10, having additional computer-executable instructions stored thereon, that when executed by the one or more computers, cause the one or more computers to perform:
determining a trust level for a user associated with the funding source; and
limiting an amount of funds available for transacting based on the determined trust level for the user.

16. The computer-readable media of claim 15,
wherein a first determined trust level corresponds to a first limit on the amount of funds available for transacting, and
wherein a second determined trust level corresponds to a second limit on the amount of funds available for transacting, the second determined trust level being different from the first determined trust level, and the second limit being different from the first limit.

17. The computer-readable media of claim 10, having additional computer-executable instructions stored thereon, that when executed by the one or more computers, cause the one or more computers to perform:
determining an amount of funds maintained with the second financial institution by a user associated with the funding source; and
limiting an amount of funds of the funding source available for transacting based on the determined amount of funds maintained with the second financial institution.

18. The computer-readable media of claim 10, having additional computer-executable instructions stored thereon, that when executed by the one or more computers, cause the one or more computers to perform:
identifying a payee of the transaction;
determining a risk score based on whether the identified payee is suspected of fraudulent activity;
determining a frequency at which the identified payee has received one or more deposits;
determining a currency threshold score based on whether the transaction exceeds a certain currency threshold; and
responsive to at least one of the determined risk score, the determined frequency, and the determined currency threshold score meeting a predetermined threshold, automatically rejecting a requested transaction.

19. An apparatus, comprising:
a processor; and
memory storing computer-readable instructions that, when executed by the processor, cause the apparatus to:
identify a funding source associated with a first financial institution different from a second financial institution;
register the funding source with the second financial institution; and
process a transaction at the second financial institution with funds drawn from the registered funding source associated with the first financial institution.

20. The apparatus of claim 19, the memory further storing computer-readable instructions that, when executed by the processor, cause the apparatus to:
validate the funding source prior to registering the funding source with the second financial institution.

21. The apparatus of claim 20, wherein validating the funding source includes:
depositing an amount of funds in the funding source at the first financial institution from an account associated with a user at the second financial institution; and
querying the user to confirm the amount of funds deposited in the funding source.

22. The apparatus of claim 21, wherein the funding source at the first financial institution is associated with the user associated with the account at the second financial institution.

23. The apparatus of claim 19, wherein the transaction is processed automatically in accordance with a predefined transfer schedule.

24. The apparatus of claim 19, the memory further storing computer-readable instructions that, when executed by the processor, cause the apparatus to:
determine a trust level for a user associated with the funding source; and
limit an amount of funds available for transacting based on the determined trust level for the user.

25. The apparatus of claim of claim 24,
wherein a first determined trust level corresponds to a first limit on the amount of funds available for transacting, and
wherein a second determined trust level corresponds to a second limit on the amount of funds available for transacting, the second determined trust level being different from the first determined trust level, and the second limit being different from the first limit.

26. The apparatus of claim 19, the memory further storing computer-readable instructions that, when executed by the processor, cause the apparatus to:
determine an amount of funds maintained with the second financial institution by a user associated with the funding source; and
limit an amount of funds of the funding source available for transacting based on the determined amount of funds maintained with the second financial institution.

27. The apparatus of claim 19, the memory further storing computer-readable instructions that, when executed by the processor, cause the apparatus to:
identify a payee of the transaction;
determine a risk score based on whether the identified payee is suspected of fraudulent activity;
determine a frequency at which the identified payee has received one or more deposits;
determine a currency threshold score based on whether the transaction exceeds a certain currency threshold; and
responsive to at least one or the determined risk score, the determined frequency, and the determined currency threshold score meeting a predetermined threshold, automatically reject a requested transaction.
